(19) United States
(12) Patent Application Publication
(10) Pub. No.: US 2007/0077352 A1
(43) Pub. Date: Apr. 5, 2007

(54) Photoresist coating system and method

(75) Inventors: June Mo Koo, Yongin-si (KR); Tae Gyu Kim, Hwaseong-si (KR); Jin Sung Lee, Seoul (KR); Chang Hoon Jung, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/511,435

(22) Filed: Aug. 29, 2006

(30) Foreign Application Priority Data
Oct. 5, 2005 (KR) 10-2005-0093498

(51) Int. Cl. B05D 3/12; B05D 7/00; B05C 11/02; B05B 7/06

(52) U.S. Cl. 427/240; 427/421.1; 118/52; 118/313

(57) ABSTRACT

A photoresist coating system and method solving an edge bead problem that occurs in photoresist coating by adding at least one of high boiling point solvent, which may generate a film on the surface of a solvent having a higher boiling point than a solvent contained in a liquid photoresist or the surface of the liquid photoresist, or by supplying a surfactant to an edge of the wafer, with the surfactant being combinable with the solvent or capable of forming a film on the solvent.

### CROSS-REFERENCE TO RELATED APPLICATIONS

This application claims the priority benefit of Korean Patent Application No. 10-2005-93498, filed on Oct. 5, 2005, in the Korean Intellectual Property Office, the disclosure of which is incorporated herein by reference.

### BACKGROUND OF THE INVENTION

1. Field of the Invention

Embodiments of the present invention relate to a photoresist coating system and method, and more particularly, to a photoresist coating system and method solving, in at least an embodiment of the present invention, an edge bead problem which occurs in photoresist coating by forming a film on the surface of a solvent having a higher boiling point than a solvent contained in a liquid photoresist or the surface of the liquid photoresist, and/or by supplying a surfactant to an edge of the wafer, the surfactant being combinable with the solvent, for example.

2. Description of the Related Art

Photoresist coating is a process which is widely used in the manufacturing of semiconductors, LCDs (Liquid Crystal Displays), MEMS (microelectromechanical systems), etc. In this coating process, photoresist is typically coated on a substrate by evenly dispersing a liquid photoresist with solvent onto the substrate and vaporizing the solvent. If the photoresist is then exposed by using a mask, for example, the exposed photoresist portion can be removed, leaving only photoresist at desired locations/arrangements on the substrate.

Photoresist coating includes depositing the photoresist from a nozzle, for example. Spinning may be used to spread photoresist across a wafer, as the substrate, through rotation of the wafer as the photodeposit is deposited from a single or limited range nozzle. In addition, additional nozzles or depositing techniques may be used. This additional nozzle/spraying technique may also referred to as a ‘spinless’ technique, though they both fall under photoresist depositing techniques. Hereinafter, conventional photoresist coating techniques will be described with reference to FIGS. 1 and 2, respectively.

FIG. 1 illustrates a conventional photoresist coating system that uses an added wafer spinning technique.

As illustrated in FIG. 1, a wafer 120 may be placed on a wafer base 130, and liquid photoresist 150 may be deposited onto the wafer 120 from a photoresist nozzle 110. The liquid photoresist 150 is photoresist that has been dissolved into a liquid form through use of a solvent. If the wafer 120 is rotated, e.g., by rotating a rotation axle 140, the liquid photoresist 150 can be spread across the wafer 120. Here, photoresist coats the wafer 120 as the solvent of the liquid photoresist 150 vaporizes. However, with this operation, an edge bead occurs at the edge of the wafer 120. The photoresist left after the solvent dissipates actually generates a higher coating on the edge of the wafer 102. This edge bead problem will be described in greater detail with reference to FIGS. 3 and 4.

FIG. 2 similarly illustrates a photoresist coating system. Here, a conventional a depositing of the photoresist, e.g., through spraying, will be discussed in greater detail.

Again, when a wafer 220 is placed on a wafer base 230, a liquid photoresist 250 may be sprayed onto the wafer 220, from a photoresist spray nozzle 210, spreading the liquid photoresist 250 across the wafer 220 through a spraying operation. Again, photoresist coats the wafer 220 as the solvent of the liquid photoresist 250 vaporizes. However, similar to the above technique that spreads the liquid photoresist through rotation of the wafer base, again an edge bead occurs at the edge of the wafer 220. Accordingly, the photoresist left after the solvent dissipates generates a higher coating on the edge of the wafer 220.

A major reason why the above edge bead occurs is because the surface area of a liquid photoresist film is larger at the edge of the wafer than towards the center of the wafer. Namely, because of this difference in surface area, more solvent vaporizes at the edge of the wafer than towards the center thereof. This will now be described in greater detail with reference to FIGS. 3 and 4.

FIG. 3 illustrating the vaporization of a solvent towards the center of a wafer and at the edge of the wafer resulting from photoresist coating.

As described above, since the liquid photoresist 310 spread over the wafer contains a solvent, a coating of the photoresist may be generated by vaporizing the solvent. In this instance, it is important for photoresist to be evenly spread and coated on a wafer. For this, the solvent should equally vaporize in different portions of the wafer.

However, as illustrated in FIG. 3, while the amount of influx (liquid photoresist deposit) is identical to the amount of oufflux (solvent vaporization) towards the center 320 of a wafer, the amount of influx is smaller than the amount of oufflux at the edge 330 of the wafer. Accordingly, more solvent vaporizes, or vaporizes more quickly, at the edge 330 of the wafer than towards the center 320 thereof. This amount of outflux being larger than the amount of influx at the edge 330 of the wafer will be described with greater detail with reference to FIG. 4.

FIG. 4 illustrates this edge bead problem, occurring at the edge of a wafer. As illustrated in portion (a) of FIG. 4, towards the center of a wafer 401, only the upper surface of a liquid photoresist 402 makes contact with air. However, at the edge of the wafer 401, the upper surface and the side surface of the liquid photoresist 402 makes contact with air. Accordingly, the solvent vaporizes in both the upper surface and the side surface at the edge of the wafer 401. Namely, since the surface area of the liquid photoresist 402 is larger at the edge of the wafer 401 than towards the center thereof, more solvent vaporizes at the edge of the wafer 401 than towards the center thereof.

As described above, since more solvent vaporizes at the edge of the wafer 401 than towards the center of the wafer 401, the density of the liquid photoresist 402 spread on the wafer 401 becomes richer at the edge of the wafer 401 than towards the center thereof, i.e., as the liquid photoresist 402 evenly spreads out across the surface of the wafer 201 more solvent is vaporized at the outer edge of the wafer 401 before all solvent vaporizes across the entire surface of the wafer 401. When the density of the liquid photoresist 402 increases, the surface tension also increases. Accordingly, as shown in portion (b) of FIG. 4, an edge bead 403 occurs at the edge of the wafer 401 and protrudes after the solvent vaporizes.

Also, when spinning is added, for further spreading photoresist, the surface velocity is larger at the edge of the wafer than towards the center of the wafer. Accordingly, the vaporization of a solvent similarly becomes larger at the edge of the wafer than towards the center of the wafer. Namely, when spinning is used, because of the difference between the surface areas and also because of the difference between the surface velocities, more solvent vaporizes at the edge of the wafer than towards the center of the wafer. Accordingly, in this environment, the edge bead problem may be even more serious.

Accordingly, photoresist should be evenly coated on a wafer. However, if the photoresist coated on the wafer protrudes at the edge of the wafer, this protrusion area becomes useless and has to be removed, e.g., cut off. Accordingly, the edge bead problem decreases the yield of semiconductors, especially as the additional bead removal is required.

To reduce the aforementioned edge bead, conventionally the pressure in a chamber containing a photoresist coating apparatus is increased during the photoresist coating. In this instance, the pressure is in inverse proportion to a boiling point of the solvent solution. Accordingly, when the pressure is increased, as described above, the boiling point of a liquid photoresist increases. Accordingly, the occurrence of the edge bead may be reduced by decreasing the speed of solvent vaporization at the edge of a wafer. However, in this case, since the pressure is also increased in the entire chamber, the boiling point towards the center of the wafer also increases. Accordingly, the processing speed of photoresist coating decreases.

Because of this conventional edge bead problem, the present inventors have found a need for a photoresist coating system and method that can solve this edge bead problem without decreasing the processing speed of photoresist coating, thereby increasing the yield of semiconductors.

### SUMMARY OF THE INVENTION

To at least overcome the above problems, embodiments of the present invention provide at least a photoresist coating system and method that can solve the aforementioned edge bead problem and evenly spread and coat photoresist on a wafer.

A solvent having a higher boiling point than a solvent contained in a liquid photoresist may be supplied at the edge of a wafer spread, with the liquid photoresist, thereby decreasing the vaporization of a solvent at the edge of the wafer, a film may also be deposited on a liquid photoresist at the edge of the wafer spread with the liquid photoresist, or a surfactant that is combinable with the solvent contained in the liquid photoresist may be applied to the edge of the wafer, thereby decreasing the vaporization difference of a solvent between the edge of the wafer and an inner area of the wafer.

Accordingly, compared with the aforementioned conventional pressurizing techniques, embodiments of the present invention provide a photoresist coating system and method that can solve such an edge bead problem without decreasing the processing speed of photoresist coating.

Additional aspects and/or advantages of the invention will be set forth in part in the description which follows and, in part, will be apparent from the description, or may be learned by practice of the invention.

To achieve at least the above and/or other aspects and advantages of the present invention include photoresist coating system, including a photoresist dispersing element to disperse a liquid photoresist to a substrate, and at least one high boiling point (HBP) solvent dispersing element to disperse an HBP solvent only to a portion of the substrate, including an edge portion of the substrate and separate from an inner portion of the substrate, the HBP solvent having a higher boiling point than a solvent used in the liquid photoresist to liquefy the liquid photoresist.

The system may further include a wafer substrate to support the substrate, the substrate being a wafer.

Further, the HBP solvent dispersing element may spray the HBP solvent on the edge portion of the substrate in the form of an aerosol after the liquid photoresist is spread over the substrate, including the edge portion, such that the HBP solvent forms a condensed liquid film on top of the liquid photoresist in the edge portion.

The HBP solvent dispersing element may sprays the HBP solvent on the edge portion of the substrate in the form of an aerosol after the liquid photoresist is spread over the substrate, including the edge portion, such that the HBP solvent forms solvent vapor relative to the edge portion.

The HBP solvent dispersing element may be provided above the edge portion of the substrate. In addition, the HBP solvent dispersing element may be rotatable above the edge portion of the substrate to selectively disperse the HBP solvent to different portions of the edge portion. The HBP solvent dispersing element may further be fixed above a portion of the edge portion of the wafer.

The HBP solvent may include includes acetophenone or propylene glycol monomethyl ether acetate (PGMEA) when the solvent used in the liquid photoresist is propylene glycol monomethyl ether acetate (PGMEA).

The system may further include a rotation axis to rotate the substrate to spread the photoresist over the substrate, including the edge portion of the substrate.

To achieve at least the above and/or other aspects and advantages of the present invention include a photoresist coating system, including a dispersing element to disperse a liquid photoresist to a substrate for spreading over the substrate, and a surfactant dispersing element to disperse a surfactant only to a portion of the substrate, including an edge portion of the substrate and separate from an inner portion of the substrate, where the liquid photoresist is spread on the substate.

The surfactant dispersing element may spray the surfactant, which is lyophilic and lyophobic to a solvent used in the liquid photoresist to liquefy the liquid photoresist along the edge portion of the substrate, after the liquid photoresist has been spread over the substrate. The surfactant may be sprayed to the edge portion to form a film on top of the liquid photoresist.

The surfactant dispersing element may spray the surfactant onto the edge portion after the liquid photoresist has been spread over the substrate and the surfactant is chemically combinable with a solvent used in the liquid photoresist to liquefy the liquid photoresist.

The surfactant may also be any one selected from a group consisting of sodium dodecylbenzene sulfonate (NaDDBS), Sodium Dodecyl Sulfate (SDS) and/or polytetrafluoroethylene (PTFE) of which hydrogen (H) at an alkyl chain is substituted with fluorine (F) to enhance a hydrophobicity of PTFE.

Further, the surfactant dispersing element may be provided above the edge portion of the substrate. Here, the surfactant dispersing element may be rotatable at the edge portion of the substrate to selectively disperse the surfactant to different portions of the edge portion. In addition, the surfactant dispersing element may be fixed above a portion of the edge portion of the substrate.

The system may still further include a rotation axis to rotate the substrate to spread the photoresist over the substrate, including the edge portion of the substrate.

To achieve at least the above and/or other aspects and advantages of the present invention include photoresist coating method, including dispersing a liquid photoresist to a substrate, dispersing a high boiling point (HBP) solvent to only to a portion of the substrate, including an edge portion of the substrate and separate from an inner portion of the substrate, the HBP solvent having a higher boiling point than a solvent used in the liquid photoresist to liquefy the liquid photoresist, controlling a vaporization difference between solvent vaporization at the edge portion of the substrate and solvent vaporization at the inner portion of the substrate.

The method may further include vaporizing the solvent from the liquid photoresist.

The HBP solvent may form a condensed liquid film on top of the liquid photoresist and/or forms a solvent vapor relative to a surface of the liquid photoresist, in the edge portion.

In addition, the dispersing of the liquid photoresist to the substrate may include rotating the substrate after dispersing the liquid photoresist onto the substrate, and the dispersing of the HBP solvent to the edge portion of the substrate includes spraying the HBP solvent onto the edge portion of the substrate by a HBP solvent dispersing element that is provided above the edge portion of the substrate.

Still further, the dispersing of the liquid photoresist to the substrate may include spraying the liquid photoresist onto the substrate, and the dispersing of the HBP solvent to the edge portion of the substrate includes spraying the HBP solvent onto the edge portion of the substrate by a HBP solvent dispersing element that is provided above the edge portion of the substrate and is rotatable to selectively disperse the HBP solvent to different portions of the edge portion.

To achieve at least the above and/or other aspects and advantages of the present invention include a photoresist coating method, including dispersing a liquid photoresist to a substrate, dispersing a surfactant to only to a portion of the substrate, including an edge portion of the substrate and separate from an inner portion of the substrate, controlling a vaporization difference between solvent vaporization at the edge portion of the substrate and solvent vaporization the inner portion of the substrate.

The method may further include vaporizing a solvent from the liquid photoresist.

The surfactant may be sprayed onto the edge portion of the substrate to form a film on the liquid photoresist or to be combined with the solvent.

In addition, the dispersing of the liquid photoresist to the substrate may include rotating the substrate after a dispersment of the liquid photoresist on the substrate, and the dispersing of the surfactant onto the edge portion of the substrate includes spraying the surfactant onto the edge portion of the substrate by a surfactant dispersing element that is provided above the edge portion of the wafer.

Further, the dispersing of the liquid photoresist to the substrate may include spraying the liquid photoresist onto the substrate, and the dispersing of the surfactant to the edge portion includes spraying the surfactant onto the edge portion of the wafer by a surfactant dispersing element that is provided above the edge portion of the wafer and is rotatable to selectively disperse the surfactant to different portions of the edge portion.

To achieve at least the above and/or other aspects and advantages of the present invention include a photoresist coating system, including a photoresist dispersing element to disperse a liquid photoresist to a substrate, the liquid photoresist including a solvent used to liquefy the liquid photoresist, and at least one dispersing element to disperse a modifying substance to a portion of the substrate, including an edge portion of the substrate and separate from an inner portion of the substrate, where the photoresist dispersing element disperses the liquid photoresist, with the modifying substance controlling a vaporization difference between solvent vaporization at the edge portion of the substrate and solvent vaporization at the inner portion of the substrate.

The modifying substance may be a high boiling point (HBP) solvent having a higher boiling point than the solvent used to liquefy the liquid photoresist to control the vaporization of the edge portion of the substrate.

Further, the modifying substance may be a surfactant that forms a film on top of dispersed liquid photoresist at the edge portion to control the vaporization of the edge portion of the substrate.

In addition, the modifying substance may be a surfactant that chemically combines with dispersed liquid photoresist at the edge portion to control the vaporization of the edge portion of the substrate. In addition, the system may include a rotation axis to rotate the substrate to spread the photoresist over the substrate, including the edge portion of the substrate.

To achieve at least the above and/or other aspects and advantages of the present invention include a photoresist coating method, including dispersing a liquid photoresist to a substrate, the liquid photoresist including a solvent used to liquefy the liquid photoresist, and dispersing a modifying substance to a portion of the substrate, including an edge portion of the substrate and separate from an inner portion of the substrate, where the photoresist dispersing element disperses the liquid photoresist, with the modifying substance controlling a vaporization difference between solvent vaporization at the edge portion of the substrate and solvent vaporization at the inner portion of the substrate.

To achieve at least the above and/or other aspects and advantages of the present invention include photoresist coating method, including dispersing a liquid photoresist to a substrate, the liquid photoresist including a solvent used to liquefy the liquid photoresist, and controlling a vaporization difference between solvent vaporization at an edge portion of the substrate and solvent vaporization at an inner portion of the substrate through a modifying substance included at a portion of the substrate separate from the inner portion of the substrate, the controlling of the vaporization difference controls a generation of a bead with the edge portion generatable by the vaporization difference.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 illustrates a conventional photoresist coating system/apparatus that adds spinning to a wafer to help spread photoresist across a wafer;

FIG. 2 illustrates a conventional photoresist coating system/apparatus that uses spraying to evenly deposit photoresist across a wafer;

FIG. 3 illustrates the vaporization of a solvent towards the center and at an edge of a wafer resulting from conventional photoresist coating techniques;

FIG. 4 illustrates a conventional edge bead occurring at the edge of a wafer;

FIG. 5 illustrates a photoresist coating system/apparatus, according to an embodiment of the present invention;

FIG. 6 illustrates a liquid photoresist at the edge of a wafer when supplied with a high boiling point solvent, according to an embodiment of the present invention;

FIG. 7 illustrates a relationship between a pressure and an amount of vaporization, according to an embodiment of the present invention;

FIG. 8 illustrates a photoresist coating system/apparatus, according to an embodiment of the present invention;

FIG. 9 illustrates an additional film formed on a liquid photoresist, at the edge of a wafer supplied with a surfactant, according to an embodiment of the present invention;

FIG. 10 illustrates how a solvent contained in a liquid photoresist may be combined with a surfactant supplied to the edge of the wafer, according to an embodiment of the present invention;

FIG. 11 illustrates a photoresist coating system, according to an embodiment of the present invention;

FIG. 12 illustrates nozzles that may be provided above the edge of a wafer, according to an embodiment of the present invention;

FIG. 13 illustrates a photoresist coating method, according to an embodiment of the present invention; and

FIG. 14 also illustrates a photoresist coating method, according to an embodiment of the present invention.

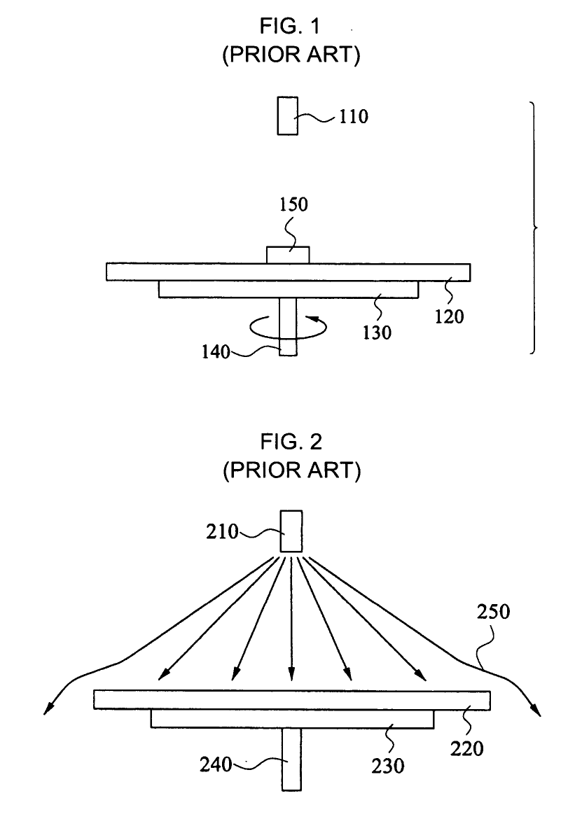

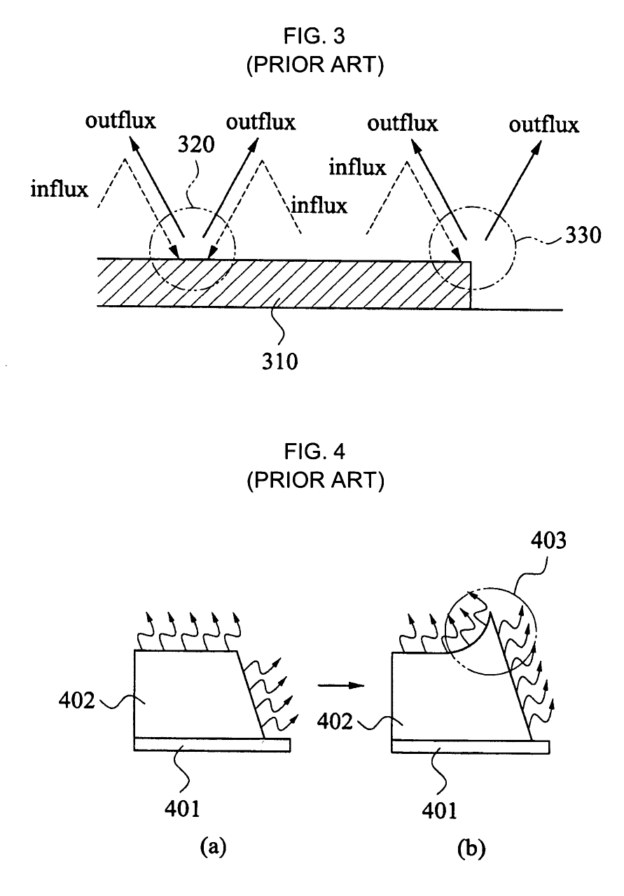

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

A photoresist coating system, according to an embodiment of the present invention may include different features, depending upon the materials available for supply to the edge of a wafer, e.g., adding a high boiling point (HBP) solvent or surfactant to the edge of the wafer. As noted above, the photoresist coating system may further include the additional features of adding spinning or additional spraying to evenly deposit liquid photoresist over a wafer.

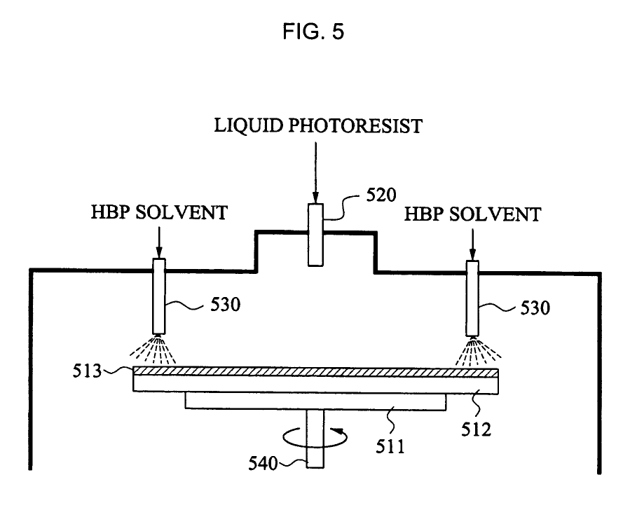

FIG. 5 illustrates a photoresist coating system, according to an embodiment of the present invention. Here, the photoresist coating system may include a wafer substrate 511, a wafer 512, a photoresist nozzle (PR nozzle) 520, and an HBP solvent nozzle 530, for example. The wafer substrate 511 may also include a rotation axle 540. A liquid photoresist 513 may be deposited onto the wafer 512 via the PR nozzle 520 and the wafer 512 may then be rotated by the rotation axle 540. In this manner, the liquid photoresist 513 may be evenly spread over the wafer 512, as illustrated in FIG. 5.

As illustrated, the wafer substrate 511 supports the wafer 512. Namely, the wafer 512 may be placed on the wafer substrate 511. In addition, the wafer substrate 511 may further include the rotation axle 540, for example. When the wafer 512 is placed on the wafer substrate 511, the PR nozzle 520 may then drop the liquid photoresist 513 on the wafer 512, and the rotation axle 540 may then revolve, rotating the wafer substrate 511.

The wafer substrate 511 and the PR nozzle 520 may be arranged similarly to the conventional systems, with at least an addition of a nozzle to disperse a high boiling point solvent (HBP solvent), such as HBP solvent nozzle 530.

The HBP solvent nozzle 530 may supply the HBP solvent to the edge of the wafer 512. In this instance, the HBP solvent has a higher boiling point than solvent contained in the liquid photoresist 513. Namely, HBP solvent may be added to the edge of the wafer 512 before or while rotating the wafer 512, for example, so as to make the deposited liquid photoresist 513 evenly spread over the wafer 512.

As illustrated in FIG. 5, at least one HBP solvent nozzle 530 may be provided above the edge of the wafer 512. Namely, only one HBP solvent nozzle 530 may be provided over a particular position above the edge of the wafer 512, according to one embodiment. In addition, a plurality of the HBP solvent nozzles 530 may be provided above the edge of the wafer 512. In FIG. 5, two HBP solvent nozzles 530 are illustrated above the edge of the wafer 512, again noting that alternative embodiments are equally available.

In addition, the HBP solvent nozzle 530 may be fixed and/or rotatably provided above the edge of the wafer 512. In the former, a plurality of the HBP solvent nozzles 530 may be provided around the circumference of the wafer 512, while in the latter, only one HBP solvent nozzle 530 may be needed, according to an embodiment of the present invention. The number of the HBP solvent nozzles 530, and/or rotation thereof, may be arbitrarily selected by those of ordinary skill in the art, depending upon the efficiency required of an operation for supplying an HBP solvent, installation cost, and the like, for example.

According to an embodiment, the HBP solvent nozzle 530 may spray the HBP solvent onto the already deposited, for example, liquid photoresist 513 at the edge of the wafer 512 in the form of an aerosol. In this case, the spraying angle the HBP solvent may be controlled to be within the appropriate range to make the HBP solvent spray only along the edge of the wafer 512.

In this embodiment, the HBP solvent may have a higher boiling point than a solvent contained in the liquid photoresist 513. Namely, the boiling point of the HBP solvent may be identical to or higher than the boiling point of the solvent, according to embodiments of the present invention.

In one example embodiment, when the solvent is propylene glycol monomethyl ether acetate (PGMEA), the HBP solvent may be acetophenone or PGMEA. Here, the boiling point of PGMEA is about 146° C. at 1 atm and the boiling point of acetophenone is about 202° C. at 1 atm.

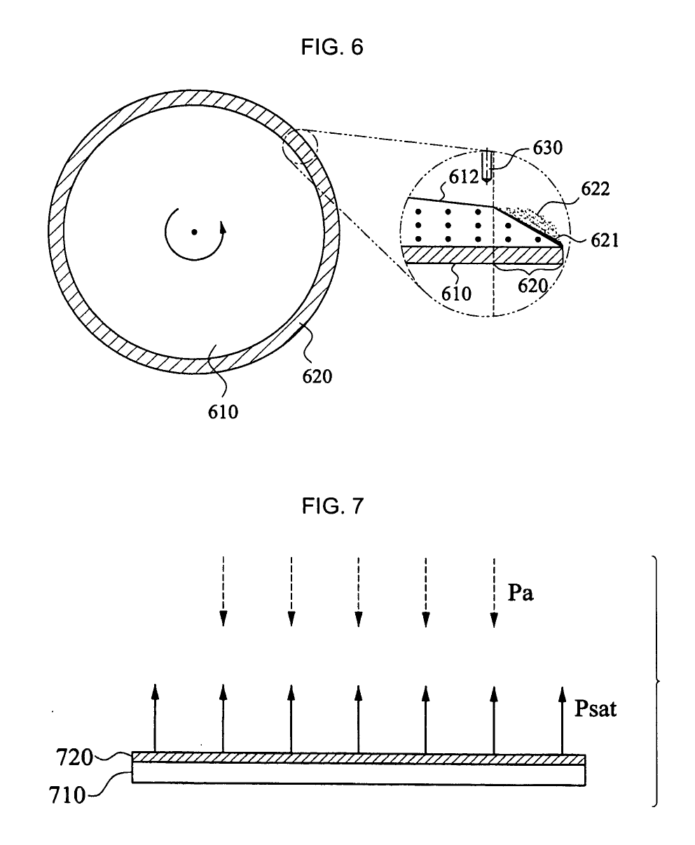

As described above, the application of the HBP solvent having a higher boiling point than a solvent of the liquid photoresist 513 helps control the vaporization of the solvent. FIGS. 6 and 7 further illustrate how the HBP solvent controls the vaporization of solvents.

FIG. 6 illustrates a liquid photoresist along the edge of a wafer supplied with a HBP solvent, according to an embodiment of the present invention.

Here, the HBP solvent may be supplied to a liquid photoresist 612 at the edge 620 of a wafer 610, e.g., via an HBP solvent nozzle 630. The HBP solvent may form a condensed liquid film 621 or a solvent vapor 622 on the liquid photoresist 612, for example. Namely, the HBP solvent may attach to the surface of the liquid photoresist 612 and form the condensed liquid film 621 thereon, and the HBP solvent may similarly form the solvent vapor 622 adjacent to the surface of the liquid photoresist 612, with the solvent vapor 622 being similar to a fog. Here, the HBP solvent may form any one of the condensed liquid film 621 and the solvent vapor 622, or a combination thereof.

As described above, when the condensed liquid film 621 or the solvent vapor 622 is formed on the liquid photoresist 612, at the edge 620 of the wafer 610, the HBP solvent may help prevent the vaporization of the solvent contained in the liquid photoresist 612. This is based on the principle that a boiling point is in inverse proportion to the pressure, and that the amount of vaporization is determined based on the pressure. This will be described in greater detail with reference to FIG. 7.

FIG. 7 illustrates the relationship between the pressure and the amount of vaporization, according to an embodiment of the present invention.

In FIG. 7, the saturated vapor pressure of a liquid photoresist 720 spread over a wafer 710 is indicated as Pₛₐₜ and the partial pressure of a solvent in the atmospheric pressure is indicated as Pₐ. Thus, as the saturated vapor pressure of the liquid photoresist 720, that is Pₛₐₜ, increases, more solvent vaporizes.

In this instance, when the amount of vaporization of the solvent is indicated as a vector, the amount of the vaporization may be determined by the following Equations 1 and 2.
Mᵢ=Jᵢ·Aᵢ Equation 1

Here, Mᵢ is a vaporization vector, Jᵢ is a plus vector of a vaporized solvent and Aᵢ is surface area.
Jᵢ∝Pₛₐₜ−Pₐ Equation 2

Here, Jᵢ is a plus vector of a vaporized solvent, Pₛₐₜ is the saturated vapor pressure of a liquid photoresist, and Pₐ is the partial pressure of a solvent in the atmospheric pressure.

In Equation 1, Mᵢ may be determined based on an internal area between Jᵢ and Aᵢ. In this case, since Aᵢ is a scalar constant, Jᵢ should be decreased in order to reduce Mᵢ.

In Equation 2, the size of Jᵢ is in proportion to the difference between Pₛₐₜ and Pₐ. Namely, when Pₐ is constant, the size of Jᵢ will increase as Pₛₐₜ increases. Conversely, as Pₛₐₜ decreases, Jᵢ will decrease.

Accordingly, if Pₛₐₜ is decreased, Jᵢ will decrease. As described above, Pₛₐₜ may be adjusted by using the priciple that the pressure of a solvent is inversely proportion to a boiling point of the solvent.

Namely, the saturated vapor pressure of a solvent having a higher boiling point is lower than a solvent having a lower boiling point. Accordingly, if the boiling point of the liquid photoresist is increased, the vaporization of the solvent contained in the liquid photoresist will be reduced.

Thus, in an embodiment of the present invention, an HBP solvent having a higher boiling point may be supplied to a liquid photoresist at the edge of a wafer on the basis of the principle described above. As illustrated in FIG. 6, when the HBP solvent is supplied to the liquid photoresist 612, and the condensed liquid film 621 and/or the solvent vapor 622 is formed on the liquid photoresist 612, the boiling point of the liquid photoresist 612 may be increased. Consequently, as the boiling point increases, the vaporization of a solvent contained in the liquid photoresist 612 decreases.

Here, as the HBP solvent is supplied to the edge 620 of the wafer 610, the decrease of vaporization of the solvent occurs only at the edge 620 of the wafer 610. Namely, since the vaporization of the solvent decreases at the edge 620 of the wafer 610 and the normal vaporization of the solvent is maintained towards the center of the wafer 610, the overall vaporization of the solvent across the wafer 610 may be adjustable to be similar at both the edge 620 and towards center of the wafer 610.

As described above, when the vaporization rate is adjusted to be similar at both the edge 620 of the wafer 610 and towards the center thereof, the aforementioned edge bead problem may be reduced. Namely, photoresist may be evenly spread and coated at the edge 620 of the wafer 610 and towards the center of the wafer 610, e.g., the ultimate photoresist density at the edge 620 and towards the center of the wafer 610 may be similar.

As further described above, according to an embodiment of the present invention, the edge bead problem may similarly be solved with only an HBP solvent nozzle supplying an HBP solvent to the edge of a wafer. Also, the edge bead problem may be solved by depositing a liquid photoresist onto a wafer and then supplying the HBP solvent to the edge of the wafer. In addition, this HBP solvent addition may be available for the embodiments where a rotation of the wafer is used to spread out the liquid photoresist and/or when sufficient nozzles are used to sufficiently cover the wafer. In this case, the processing speed of photoresist coating is not decreased.

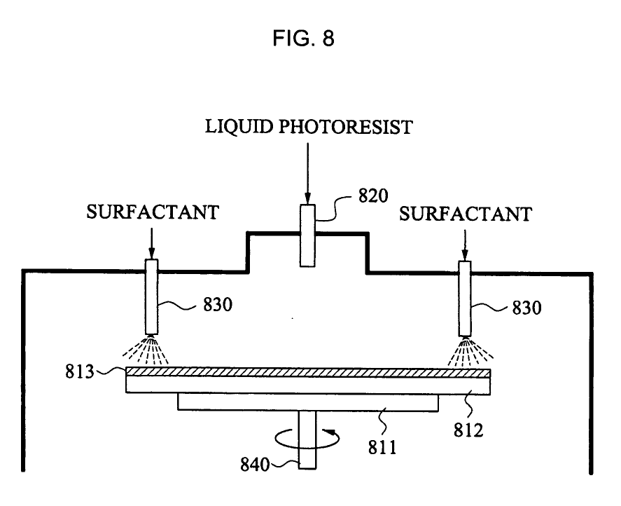

Similar to above, FIG. 8 illustrates a photoresist coating system, according to an embodiment of the present invention.

Here, the illustrated photoresist coating system, and similar to FIG. 5, includes a wafer substrate 811, a PR nozzle 820 and an additional nozzle, such as the surfactant nozzle 830. The wafer substrate 811 may further include a rotation axle 840 for spinning the wafer substrate 811, for example, for helping spread deposited photoresist across the wafer 812.

Again, the wafer substrate 811 may be used to support the wafer 812, such that when the wafer 812 is placed on the wafer substrate 811, the wafer substrate 811 may be rotatable about the rotation axle 840. In particular, after the wafer 812 is placed on the wafer substrate 811, the PR nozzle 820 may deposit the liquid photoresist 813 onto the wafer 812, the rotation axle 840 may rotate the wafer substrate 811, and the liquid photoresist 813 may be evenly spread over the surface of the wafer 812.

The surfactant nozzle 830 can be used to supply at least a surfactant to the liquid photoresist 813 at the edge of the wafer 812. Namely, at least a surfactant may be applied to the edge of the wafer 812 before or while rotating the wafer 812, for example.

As illustrated in FIG. 8, at least one surfactant nozzle 830 may be provided above the edge of the wafer 812. Namely, only one surfactant nozzle 830 may be needed to be provided over a particular position above the edge. In addition, a plurality of the surfactant nozzles 830 may be provided above different portions of the edge of the wafer 812. For example, in FIG. 8, two surfactant nozzles 830 are illustrated above the edge of the wafer 812. Although the rotation of the wafer for spreading the photoresist is described, it is equally noted that multiple nozzles may also be used to spray deposit the photoresist, for example.

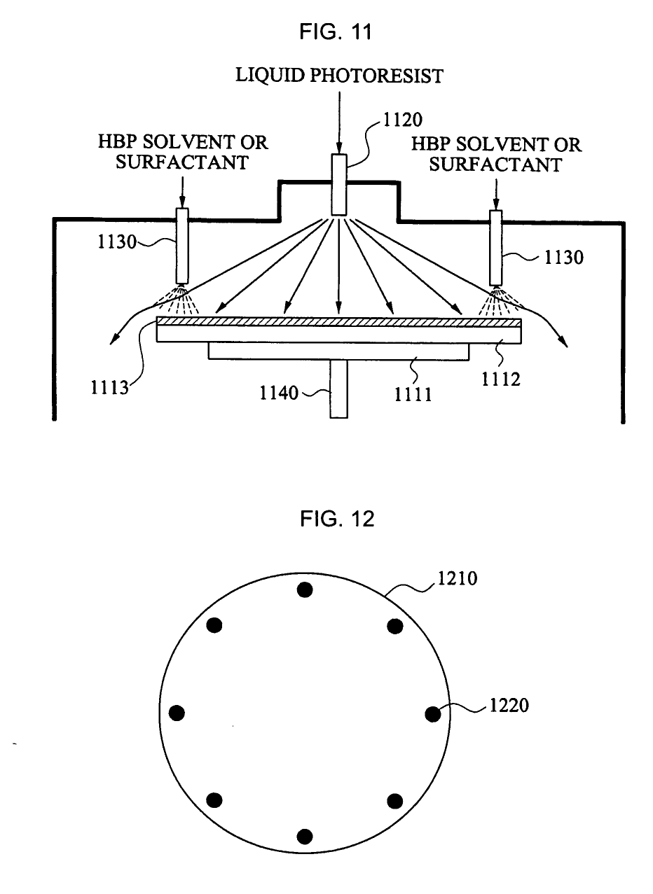

As noted, the surfactant nozzle 830 may be fixed above the edge of the wafer 812, or rotatably provided above the edge of the wafer 812. In the former, a plurality of the surfactant nozzles 830 may be provided around the circumference of the wafer 812, while in the latter only one surfactant nozzle 830 may be necessarily provided. The number of the surfactant nozzles 830 and rotation thereof may be arbitrarily selected by those of ordinary skill in the art, depending upon the efficiency required of an operation for supplying a surfactant, installation cost, and the like, for example. These arrangements may be available for regardless of whether rotation of the wafer is also implemented, e.g., see FIGS. 11 and 12 for non-rotating embodiments.

Here, the surfactant nozzle 830 may spray the surfactant on the liquid photoresist 813 at the edge of the wafer 812 in the form of an aerosol, for example. In this case, the angle set for spraying the surfactant may be controlled to be within an appropriate range to ensure that the surfactant is sprayed only on the edge of the wafer 812, for example.

According to an embodiment of the present invention, the surfactant may also have a higher boiling point than a solvent contained in the liquid photoresist 813. Namely, the boiling point of the surfactant may be identical to or higher than the boiling point of the solvent.

As only an example, the surfactant may be any one selected from the group of sodium dodecylbenzene sulfonate (NaDDBS), Sodium Dodecyl Sulfate (SDS) and polytetrafluoroethylene (PTFE) of which hydrogen(H) at an alkyl chain is substituted with fluorine (F) to enhance a hydrophobicity of PTFE.

As described above, the supplying of the surfactant having the above-described properties to the liquid photoresist 813 at the edge of the wafer 812 helps control the vaporization of the solvent.

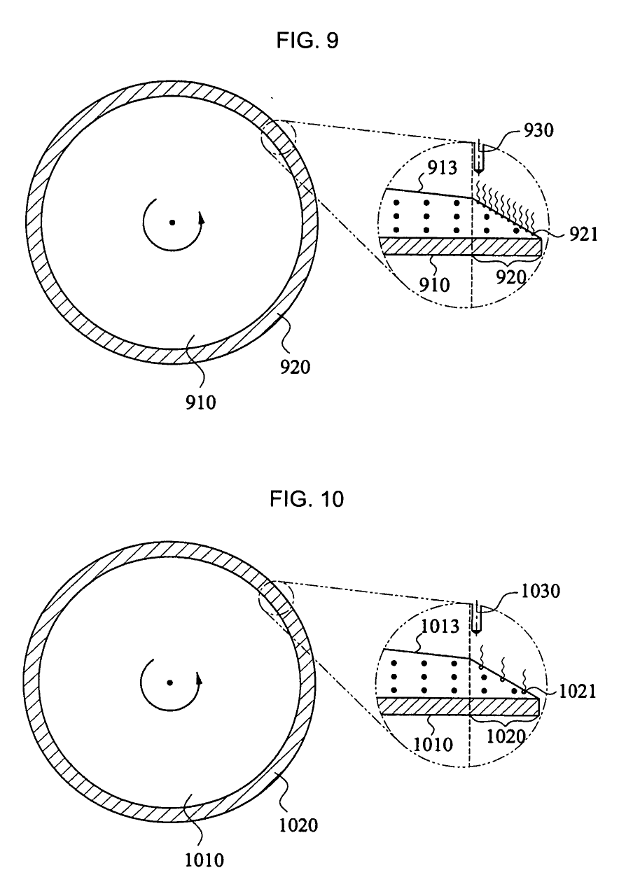

In particular, FIG. 9 illustrates a surfactant film, formed on a liquid photoresist at the edge of a wafer, according to an embodiment of the present invention.

As illustrated, a surfactant 921 may be supplied to a liquid photoresist 913 at the edge 920 of a wafer 910, e.g., via a surfactant nozzle 930. The surfactant 921 may form a film on the liquid photoresist 913. To form the film, the surfactant 921 may be configured as a surfactant having lyophilic and lyophobic properties with respect to a solvent contained in the liquid photoresist 913, for example.

Namely, when the surfactant 921 is supplied to the liquid photoresist 913, particles of surfactant 921 float over the liquid photoresist 913, as the surfactant 921 is lyphilic and lyophobic to the solvent. The particles of the surfactant floating may thus form a film on the liquid photoresist 913.

Accordingly, with this formed film, the surface area of the liquid photoresist 913 making contact with air may be reduced. As described in Equation 1, an amount of vaporization is in proportion to the size of the surface area. Accordingly, when the surface area is decreased, the vaporization of the solvent contained in the liquid photoresist 913 also decreases.

In this instance, if the surfactant is supplied only to the edge 920 of the wafer 910, a decrease of vaporization of the solvent occurs only at the edge 920 of the wafer 910. Namely, the vaporization of the solvent is controlled to decrease at the edge 920 of the wafer 910 while being maintained towards the center of the wafer 910. Accordingly, the vaporization of the solvent may be adjusted to be similar, if not almost identical, both at the edge 920 of the wafer 910 and towards the center of the wafer 910. When the vaporization of the solvent becomes similar at the edge 920 of the wafer 910 and towards the center of the wafer 910, the aforementioned edge bead problem may be reduced. Namely, photoresist may thus be evenly spread and coated at both the edge 920 of the wafer 910 and towards the center of the wafer 910, while having the same photoresist density.

FIG. 10 similarly illustrates how a solvent contained in a liquid photoresist may be combined with a surfactant supplied to the edge of the wafer, according to an embodiment of the present invention. A surfactant 1021 may be supplied to a liquid photoresist 1013, at the edge 1020 of a wafer 1010, e.g., via a surfactant nozzle 1030. The surfactant 1021 may combine with the solvent contained in the liquid photoresist 1013. In this case, the combination is a chemical combination. To be combined with the solvent, the surfactant 1021 may be configured as various types of surfactants including a component which is chemically combinable, if not easily chemically combinable, with the type of solvent used.

As described above, when the surfactant 1021 is chemically combined with the solvent, the vaporization rate of the solvent decreases in comparison with a pure solvent because of the chemical combination. Accordingly, the vaporization of the solvent may also be controlled to decrease.

Here, the decrease of vaporization of the solvent occurs only at the edge 1020 of the wafer. This is because the surfactant 1021 is supplied only to the edge 1020 of the wafer 1010. Namely, since the vaporization of the solvent decreases at the edge 1020 of the wafer 1010 and the vaporization of the solvent is maintained towards the center of the wafer 1010, the vaporization of the solvent may be controlled to be similar both at the edge 1020 of the wafer 1010 and towards the center of the wafer 1010. As described above, when the vaporization rate is controlled to be similar both at the edge 1020 of the wafer 1010 and towards the center of the wafer 1010, the aforementioned edge bead problem may be reduced. Namely, photoresist may be evenly spread and coated at the edge 1020 of the wafer 1010 and towards the center of the wafer 1010, while having the same photoresist density.

Also, as described above, according to an embodiment of the present invention, the aforementioned edge bead problem may similarly be solved by using a surfactant nozzle to supply a surfactant to the edge of a wafer.

As noted above, the photoresist coating systems of the present invention may be embodied with the illustrated additional wafer spinning techniques, to help spread deposited photoresist, or may equally be implemented without such spinning operations though sufficient depositing/dispersing elements to spread the photoresist across a wafer. As an example, and for completeness, such a spraying embodiment will be briefly described now with reference to FIGS. 11 and 12.

FIG. 11 illustrates a photoresist coating system, according to an embodiment of the present invention. Here, the photoresist coating system may include a wafer substrate 1111, a PR nozzle 1120, and an HBP solvent or surfactant nozzle 1130, for example. The wafer substrate 1111 may includes an axis 1140 for supporting the wafer substrate 1111, rather than the aforementioned rotation axis that may be used for rotating the wafer substrate to help spread photoresist over the wafer.

Accordingly, here, the photoresist coating system may not rotate the wafer 1112 to evenly spread the liquid photoresist 1113 on the wafer 1112, but may evenly spray the liquid photoresist 1113 over the wafer 1112 via the photoresist nozzle 1120, for example.

In addition, similar to above, the photoresist coating system, according to an embodiment of the present invention, may further apply an HBP solvent or surfactant nozzles 1130, respectively supplying an HBP solvent or a surfactant to the edge of the wafer 1112, similar to above.

In addition, a plurality of the HBP solvent or surfactant nozzles 1130, respectively supplying an HBP solvent or a surfactant, may be provided above the edge of the wafer 1112 in order to evenly spray the HBP solvent or the surfactant over the entire edge of the wafer 1112. Namely, since the wafer 1112 may not be made to rotate, like the above embodiments of FIGS. 5 and 8, the plurality of the HBP solvent or surfactant nozzles 1130 may evenly spray the HBP solvent or the surfactant all over the edge of the wafer 1112.

As an example, FIG. 12 illustrates a configuration of nozzles provided above the edge of a wafer, according to an embodiment of the present invention. As illustrated in FIG. 12, a plurality of nozzles 1220 may be provided above the edge of a wafer 1210, e.g., around the circumference of the wafer 1210. Each of the plurality of nozzles 1220 may adjust the range of spraying the HBP solvent or the surfactant in order to make the same evenly spread all over the edge of the wafer 1210, for example.

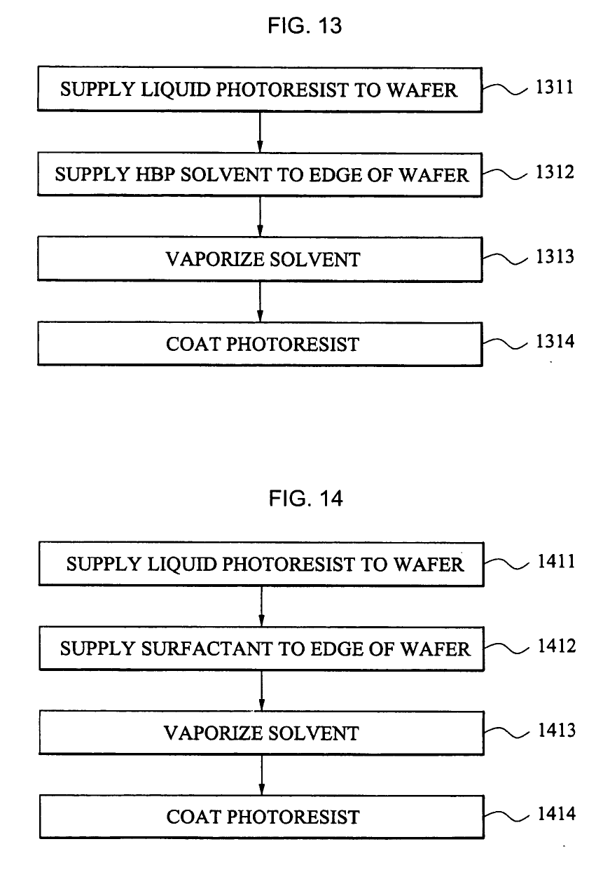

FIG. 13 illustrates a photoresist coating method, according to an embodiment of the present invention. In operation 1311, a liquid photoresist may be deposited to a wafer. In operation 1312, an HBP solvent may be supplied to the edge of the wafer, where the HBP solvent has a higher boiling point than a solvent contained in the liquid photoresist.

In an embodiment, in operation 1312, the HBP solvent may form a condensed liquid film on the liquid photoresist or form solvent vapor above the liquid photoresist, for example, depending on the chemical makeup of the HBP solvent. Accordingly, vaporization of the solvent contained in the liquid photoresist can be controlled to decrease at the edge of the wafer compared to an inner area of the wafer, thereby reducing the occurrence of the aforementioned edge bead problem.

If spinning is added to help spread the photoresist across the surface of the wafer, operation 1311 may include dropping the liquid photoresist on the wafer and rotating the wafer. Similarly, operation 1312 may include spraying the HBP solvent on the edge of the rotating wafer via at least one HBP solvent nozzle provided above the edge of the wafer. When spinning is not added, or the distribution or photoresist is primarily done through spraying, operation 1311 may include evenly spraying the liquid photoresist on the wafer. Similarly, operation 1312 may then include spraying the HBP solvent on the edge of the wafer via at least one HBP solvent nozzle provided, and potentially rotating, above the edge of the wafer.

After performing operation 1312, solvent contained in the liquid photoresist may be vaporized, in operation 1313. After the solvent is sufficiently vaporized, the resultant photoresist may be considered to be evenly coated on the wafer in operation 1314. In this manner, the photoresist coating system may include photoresist coating while reducing the aforementioned edge bead problem.

FIG. 14 illustrates a photoresist coating method, according to an embodiment of the present invention. In operation 1411, a liquid photoresist may be deposited to a wafer. In operation 1412, a surfactant may be deposited to the liquid photoresist at the edge of the wafer, e.g., after the liquid photoresist is spread over the wafer.

In operation 1412, the surfactant may be sprayed on the edge of the wafer to form a film on the liquid photoresist or be combined with the solvent. Accordingly, the vaporization of the solvent contained in the liquid photoresist can be controlled to be decreased at the edge of the wafer compared to an inner area of the wafer, thereby reducing the aforementioned edge bead problem.

If spinning is added to help spread the photoresist across the surface of the wafer, operation 1411 may be performed by depositing the liquid photoresist on the wafer and rotating the wafer. Similarly, operation 1412 may be performed by spraying the surfactant on the edge of the rotating wafer via at least one surfactant nozzle provided above the edge of the wafer. When spinning is not added, or the distribution or photoresist is primarily done through spraying, operation 1411 may include evenly spraying the liquid photoresist on the wafer. Similarly, operation 1412 may include spraying the surfactant on the edge of the wafer via at least one surfactant nozzle provided, and potentially rotating, above the edge of the wafer.

After performing operation 1412, the liquid photoresist may be vaporized, in operation 1413. After the solvent is sufficiently vaporized, the resultant photoresist may be considered to be evenly coated on the wafer in operation 1414. In this manner, the photoresist coating method may include photoresist coating while reducing the aforementioned edge bead problem.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A photoresist coating system, comprising:
a photoresist dispersing element to disperse a liquid photoresist to a substrate; and
at least one high boiling point (HBP) solvent dispersing element to disperse an HBP solvent only to a portion of the substrate, including an edge portion of the substrate and separate from an inner portion of the substrate, the HBP solvent having a higher boiling point than a solvent used in the liquid photoresist to liquefy the liquid photoresist.

2. The system of claim 1, further comprising a wafer substrate to support the substrate, the substrate being a wafer.

3. The system of claim 1, wherein the HBP solvent dispersing element sprays the HBP solvent on the edge portion of the substrate in the form of an aerosol after the liquid photoresist is spread over the substrate, including the edge portion, such that the HBP solvent forms a condensed liquid film on top of the liquid photoresist in the edge portion.

4. The system of claim 1, wherein the HBP solvent dispersing element sprays the HBP solvent on the edge portion of the substrate in the form of an aerosol after the liquid photoresist is spread over the substrate, including the edge portion, such that the HBP solvent forms solvent vapor relative to the edge portion.

5. The system of claim 1, wherein the HBP solvent dispersing element is provided above the edge portion of the substrate.

6. The system of claim 5, wherein the HBP solvent dispersing element is rotatable above the edge portion of the substrate to selectively disperse the HBP solvent to different portions of the edge portion.

7. The system of claim 5, wherein the HBP solvent dispersing element is fixed above a portion of the edge portion of the substrate.

8. The system of claim 1, wherein the HBP solvent includes acetophenone or propylene glycol monomethyl ether acetate (PGMEA) when the solvent used in the liquid photoresist is propylene glycol monomethyl ether acetate (PGMEA).

9. The system of claim 1, further comprising a rotation axis to rotate the substrate to spread the photoresist over the substrate, including the edge portion of the substrate.

10. A photoresist coating system, comprising:
a dispersing element to disperse a liquid photoresist to a substrate for spreading over the substrate; and
a surfactant dispersing element to disperse a surfactant only to a portion of the substrate, including an edge portion of the substrate and separate from an inner portion of the substrate, where the liquid photoresist is spread on the substate.

11. The system of claim 10, wherein the surfactant dispersing element sprays the surfactant, which is lyophilic and lyophobic to a solvent used in the liquid photoresist to liquefy the liquid photoresist along the edge portion of the substrate, after the liquid photoresist has been spread over the substrate.

12. The system of claim 11, wherein the surfactant is sprayed to the edge portion to form a film on top of the liquid photoresist.

13. The system of claim 10, wherein the surfactant dispersing element sprays the surfactant onto the edge portion after the liquid photoresist has been spread over the substrate and the surfactant is chemically combinable with a solvent used in the liquid photoresist to liquefy the liquid photoresist.

14. The system of claim 10, wherein the surfactant is any one selected from a group consisting of sodium dodecylbenzene sulfonate (NaDDBS), Sodium Dodecyl Sulfate (SDS) and/or polytetrafluoroethylene (PTFE) of which hydrogen(H) at an alkyl chain is substituted with fluorine (F) to enhance a hydrophobicity of PTFE. .

15. The system of claim 10, wherein the surfactant dispersing element is provided above the edge portion of the substrate.

16. The system of claim 15, wherein the surfactant dispersing element is rotatable at the edge portion of the substrate to selectively disperse the surfactant to different portions of the edge portion.

17. The system of claim 15, wherein the surfactant dispersing element is fixed above a portion of the edge portion of the substrate.

18. The system of claim 10, further comprising a rotation axis to rotate the substrate to spread the photoresist over the substrate, including the edge portion of the substrate.

19. A photoresist coating method, comprising:
dispersing a liquid photoresist to a substrate;
dispersing a high boiling point (HBP) solvent to only to a portion of the substrate, including an edge portion of the substrate and separate from an inner portion of the substrate, the HBP solvent having a higher boiling point than a solvent used in the liquid photoresist to liquefy the liquid photoresist, controlling a vaporization difference between solvent vaporization at the edge portion of the substrate and solvent vaporization at the inner portion of the substrate.

20. The method of claim 19, further comprising vaporizing the solvent from the liquid photoresist.

21. The method of claim 19, wherein the HBP solvent forms a condensed liquid film on top of the liquid photoresist and/or forms a solvent vapor relative to a surface of the liquid photoresist, in the edge portion.

22. The method of claim 19, wherein the dispersing of the liquid photoresist to the substrate includes rotating the substrate after dispersing the liquid photoresist onto the substrate, and the dispersing of the HBP solvent to the edge portion of the substrate includes spraying the HBP solvent onto the edge portion of the substrate by a HBP solvent dispersing element that is provided above the edge portion of the substrate.

23. The method of claim 19, wherein the dispersing of the liquid photoresist to the substrate includes spraying the liquid photoresist onto the substrate, and the dispersing of the HBP solvent to the edge portion of the substrate includes spraying the HBP solvent onto the edge portion of the substrate by a HBP solvent dispersing element that is provided above the edge portion of the substrate and is rotatable to selectively disperse the HBP solvent to different portions of the edge portion.

24. A photoresist coating method, comprising:
dispersing a liquid photoresist to a substrate;
dispersing a surfactant to only to a portion of the substrate, including an edge portion of the substrate and separate from an inner portion of the substrate, controlling a vaporization difference between solvent vaporization at the edge portion of the substrate and solvent vaporization the inner portion of the substrate.

25. The method of claim 24, further comprising vaporizing a solvent from the liquid photoresist.

26. The method of claim 24, wherein the surfactant is sprayed onto the edge portion of the substrate to form a film on the liquid photoresist or to be combined with the solvent.

27. The method of claim 24, wherein the dispersing of the liquid photoresist to the substrate includes rotating the substrate after a dispersment of the liquid photoresist on the substrate, and the dispersing of the surfactant onto the edge portion of the substrate includes spraying the surfactant onto the edge portion of the substrate by a surfactant dispersing element that is provided above the edge portion of the substrate.

28. The method of claim 24, wherein the dispersing of the liquid photoresist to the substrate includes spraying the liquid photoresist onto the substrate, and the dispersing of the surfactant to the edge portion includes spraying the surfactant onto the edge portion of the wafer by a surfactant dispersing element that is provided above the edge portion of the wafer and is rotatable to selectively disperse the surfactant to different portions of the edge portion.

29. A photoresist coating system, comprising:
a photoresist dispersing element to disperse a liquid photoresist to a substrate, the liquid photoresist including a solvent used to liquefy the liquid photoresist; and
at least one dispersing element to disperse a modifying substance to a portion of the substrate, including an edge portion of the substrate and separate from an inner portion of the substrate, where the photoresist dispersing element disperses the liquid photoresist, with the modifying substance controlling a vaporization difference between solvent vaporization at the edge portion of the substrate and solvent vaporization at the inner portion of the substrate.

30. The system of claim 29, wherein the modifying substance is a high boiling point (HBP) solvent having a higher boiling point than the solvent used to liquefy the liquid photoresist to control the vaporization of the edge portion of the substrate.

31. The system of claim 29, wherein the modifying substance is a surfactant that forms a film on top of dispersed liquid photoresist at the edge portion to control the vaporization of the edge portion of the substrate.

32. The system of claim 29, wherein the modifying substance is a surfactant that chemically combines with dispersed liquid photoresist at the edge portion to control the vaporization of the edge portion of the substrate.

33. The system of claim 29, further comprising a rotation axis to rotate the substrate to spread the photoresist over the substrate, including the edge portion of the substrate.
